(19) United States
(12) Patent Application Publication
(10) Pub. No.: US 2008/0057906 A1
(43) Pub. Date: Mar. 6, 2008

(54) Dual authentication method in mobile networks

(75) Inventors: Jong-Hyouk Lee, Daejeon (KR); Soo-Jin Jung, Daegu (KR); Young-Ju Han, Suwon (KR); Hun-Jung Lim, Daejeon (KR); Tai-Myoung Chung, Seoul (KR)

Correspondence Address: EDWARDS ANGELL PALMER & DODGE LLP, P.O. BOX 55874, BOSTON, MA, 02205, US

(73) Assignee: Sungkyunkwan University Foundation for Corporate Collaboration, Suwon (KR)

(21) Appl. No.: 11/709,966

(22) Filed: Feb. 22, 2007

(30) Foreign Application Priority Data
Aug. 30, 2006 (KR) 10-2006-0082604

(51) Int. Cl. H04M 3/16

(52) U.S. Cl. 455/411

(57) ABSTRACT

Disclosed is a method for safely and rapidly performing a dual authentication when a mobile node is in a ping-pong state in a mobile network based on mobile IPv6. When a mobile node is in a ping-pong state where the mobile node is moving in an overlapping coverage area of a previous access router and a new access router, the method allows the previous access router to perform an authentication operation by reusing authentication information having been used in the previous access router, without requesting information required for authentication to an Authentication, Authorization, and Accounting (AAA) server. Thus, the authentication of the mobile node in an AAA environment can be safely and rapidly performed, an authentication failure in the ping-pong state can be prevented.

### CROSS-REFERENCE TO RELATED APPLICATION

The present application claims, under 35 U.S.C. §119(a), the benefit of Korean Patent Application No. 10-2006-0082604, filed Aug. 30, 2006, the entire contents of which are hereby incorporated by reference.

### BACKGROUND OF THE INVENTION

1. Field of the Invention

The present invention relates to an authentication method in the filed of information security technology, and more particularly to a method for safely and rapidly performing a dual authentication when a mobile node is in a ping-pong state in a mobile network based on mobile IPv6.

2. Background Art

A wireless communication technology is one of the indispensable communication technologies in a ubiquitous environment. The number of mobile nodes using the wireless communication technology is increasing in a geometric progression, so that the necessity of an authentication technology of the nodes is also increasing. Particularly, the wireless communication environment has weaknesses in security, such as wiretapping of data communication of mobile nodes, fabrication/falsification or distortion of information, illegal use of data, etc. In such a wireless communication environment, when authentication of nodes is not properly accomplished, secret information may be disclosed to unauthenticated users.

Particularly, in order to realize an Authentication, Authorization and Accounting (AAA) service in a mobile network, it is necessary to properly accomplish authentication of mobile nodes. In the AAA service environment, the authentication of each mobile node is performed by an AAA server. Also, upon a handoff of a mobile node, the mobile node transmits a re-authentication request message for re-authentication of the mobile node to the AAA server, and the AAA server checks the re-authentication request message received from the mobile node, and performs a re-authentication procedure when the re-authentication of the mobile node is valid. However, there is a problem in that as a mobile node gets further away from its own AAA server, it takes a longer time period to transfer the re-authentication request message.

An identity-based encryption (IBE) scheme, which does not require a public key infrastructure (PKI), has been proposed by Shamir. The IBE scheme can use an identifier (such as an address or e-mail) easily distinguished by persons as a key, so that the IBE scheme can have an advantage of eliminating the need of the PKI used in public key-based encryption schemes. However, the conventional encryption scheme has a problem in that when it is impossible to exactly recognize the moving direction of a mobile node because the mobile node is in a ping-pong state, the authentication failure rate increases.

When a mobile node is located in an overlapping coverage area of different access routers, the mobile node goes into a ping-pong state. Overlapping access routers causing a ping-pong phenomenon are illustrated in FIG. 2. When a mobile node (MN) has entered a ping-pong state, the mobile node cannot determine which access router (AR) the mobile node will be handed-off into, and a buffering problem is caused. For example, when a mobile node is located in an overlapping coverage area of access routers A and B, the mobile node is recognized to be in a ping-pong state, and continuously receives router advertisement messages generated from access routers A and B. Then, the mobile node must respond to the router advertisement messages. Also, the mobile node must perform an address auto-configuration function or the like according to an operation of mobile IPv6. In such a situation, when the mobile node is handed-off from a first network managed by access router A just to a second network managed by access router B, an operation based on the existing mobile IPv6 can be utilized. However, in such a ping-pong state, when the mobile node is not handed-off to the second network managed by access router B, but moves back to the first network managed by access router A, it is necessary to again create a re-authentication message. Then, when the mobile node moves again to the second network managed by access router B, it is necessary for the mobile node to again create a re-authentication message through access router B and then to be re-authenticated by the AAA server. Such a problem increases the failure rate in the authentication procedure of the mobile node, which results in a failure of the handoff of the mobile node in an AAA service environment. Such repetition and failure of the authentication procedure are inevitable in the ping-pong state where the mobile node is located in an overlapping coverage area of access routers. In brief, when a mobile node enters a ping-pong state, it is impossible to predict the moving direction of the mobile node, and the access router and mobile node are faced with a buffering problem. Thus, authentication and handoff failure rates increase.

A node authentication scheme, which functions as a core to manage mobile nodes in an AAA environment, is required to be designed in consideration of both safety and efficiency. An authentication failure allows unauthenticated users to access, fabricate, falsify, destroy or illegally use data.

### SUMMARY OF THE INVENTION

Accordingly, the present invention has been made to solve the above-mentioned problems occurring in the prior art, and an object of the present invention is to rapidly and safely perform an authentication of a mobile node in an AAA environment.

Another object of the present invention is to solve the buffering problem and prevent an authentication failure in a ping-pong state, by performing a dual authentication when the mobile node enters the ping-pong state.

In order to accomplish these objects, the present invention, in one aspect, provides a dual authentication method for a mobile node which moves in an overlapping coverage area of a previous access router (pAR) and a new access router (nAR), in which in which, during the dual authentication, a previous access router performs authentication by reusing authentication information having been used in the previous access router, without requesting information required for authentication to an AAA server, thereby more rapidly performing the authentication of the mobile node.

In a preferred embodiment, the dual authentication method can be performed by using an IBE scheme.

In another preferred embodiment, the dual authentication method can be performed in a Mobile IPv6 environment.

In still another preferred embodiment, when the mobile node is in a ping-pong state, it may create a registration message based on a router advertisement message received from the new access router.

Preferably, the mobile node transmits the registration message to both the previous access router and the new access router at the same time.

Also preferably, when the new access router receives an authentication request message from the mobile node, the new access router forwards the authentication request message to the AAA server.

Suitably, the AAA server transmits new Care-of-Address (CoA) information of the mobile node to a home agent (HA) so as to notify the home agent that the mobile node has moved to a new network.

Also suitably, the home agent transmits to the AAA server a confirmation message that the new CoA information of the mobile node has been recorded, and the AAA server creates a registration confirmation message to be transmitted to the new access router.

Preferably, the AAA server transmits the created registration confirmation message to the new access router, and the new access router authenticates the mobile node as soon as the new access router receives the registration confirmation message from the AAA server.

The new access router, suitably, transmits to the mobile node the registration confirmation message received from the AAA server, and the mobile node receives the registration confirmation message from the new access router and acquires a session key created by the home agent, thereby safely communicating with the new access router.

In another aspect, the present invention provides a dual authentication method, comprising the steps of: (a) creating, by the mobile node, a registration message based on a router advertisement message received from the new access router; (b) simultaneously transmitting the registration messages from the mobile node to the new access router and the previous access router; (c) performing authentication by the previous access router itself, without committing an authentication request message, which has been received from the mobile node, to an AAA server; (d) transmitting, by the previous access router having performed the authentication, a response message to the registration message to the mobile node; (e) authenticating, by the mobile node, the response message received from the previous access router; (f) receiving, by the new access router, an authentication request message from the mobile node; (g) forwarding the authentication request message from the new access router to the AAA server in order to request authentication; (h) authenticating, by the AAA server, the authentication request message of the mobile node, which has been transmitted from the new access router; (i) transmitting new CoA information of the mobile node from the AAA server to a home agent, in order to notify the home agent that the mobile node has moved to a new network; (j) recording, by the home agent, the new CoA information of the mobile node in a Binding Update List (BUL) of the home agent, thereby confirming that a handover has been performed; (k) transmitting, from the home agent to the AAA server, a confirmation message that the new CoA information of the mobile node has been recorded; (l) creating, by the AAA server, a registration confirmation message to be transmitted to the new access router; (m) transmitting the created registration confirmation message from the AAA server to the new access router; (n) receiving, by the new access router, the registration confirmation message transmitted from the AAA server, and authenticating the mobile node; and (o) transmitting the registration confirmation message, which the new access router has received from the AAA server, from the new access router to the mobile node.

In a preferred embodiment, after authenticating the response message received from the previous access router, the mobile node communicates with the previous access router by using a session key received from the previous access router.

In another preferred embodiment, the mobile node acquires a session key created by the home agent, thereby safely communicating with the new access router.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view explaining a dual authentication method according to an embodiment of the present invention;

FIG. 2 is a view illustrating overlapping access routers which cause a ping-pong phenomenon;

FIG. 3 illustrates graphs showing authentication failure rates as a function of the moving speeds of a mobile node based on the present invention and the prior art; and

FIG. 4 illustrates graphs showing authentication failure rates as a function of the signal sizes based on the present invention and the prior art.

### DETAILED DESCRIPTION OF THE PREFERRED EMBODIMENTS

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

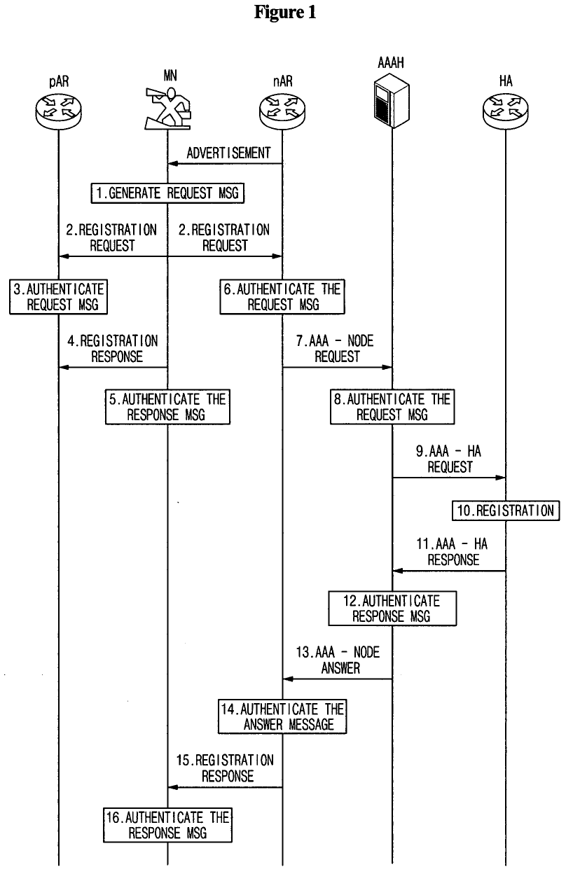

FIG. 1 is a schematic view explaining a dual authentication method according to an embodiment of the present invention. FIG. 1 shows an entire messaging process of performing a rapid and safe authentication by using a dual authentication scheme when a mobile node is in a ping-pong state in an AAA environment. When a mobile node (MN) is located in an overlapping coverage area of different access routers, the mobile node receives a router advertisement message from a nAR. In this case, the mobile node is in a state where the mobile node can receive data from a pAR as well as data from the nAR. As a result, the mobile node enters a ping-pong state where the mobile node cannot determine the direction of the mobile node itself. The entire messaging process of performing a dual authentication method according to an embodiment of the present invention in such a ping-pong state will now be described with reference to FIG. 1.

Messaging Process

(1) A mobile node generates a registration message based on a router advertisement message received from a nAR. The generated registration message includes a message to register with a pAR and a message to register with the nAR.

(2) Since the mobile node is in a ping-pong state, the mobile node cannot determine the exact moving direction of the mobile node itself. Therefore, the mobile node simultaneously transmits the registration messages to the nAR and the pAR.

(3) The pAR does not commit (i.e., does not forward) an authentication request message, which has been received from the mobile node, to a home AAA server (AAAH), and the pAR itself performs authentication. According to the present invention, the pAR preserves information relating to authentication previously performed for the mobile node. Therefore, when an authentication request is again received from the mobile node, the pAR does not request authentication of the mobile node to the AAAH, and directly performs authentication of the mobile node by using the preserved authentication-related information, thereby reducing the time necessary for forwarding an authentication message.

(4) The pAR, having performed the authentication, transmits a response message to the registration message to the mobile node.

(5) The mobile node authenticates the response message received from the pAR. Thereafter, the mobile node can safely communicate with the pAR by means of a session key contained in the response message received from the pAR.

(6) The nAR receives an authentication request message of the mobile node.

(7) Since the nAR has no information about the mobile node, the nAR forwards the authentication request message to an AAAH for the purpose of requesting authentication, unlike the pAR.

(8) The AAAH authenticates the authentication request message of the mobile node, which has been transmitted from the nAR.

(9) In order to notify a home agent (HA) that the mobile node has moved to a new network, the AAAH transmits new Care-of-Address (CoA) information of the mobile node to the home agent.

(10) The home agent records the new CoA information of the mobile node in its own Binding Update List (BUL), thereby determining that a handover has been performed.

(11) The home agent transmits a confirmation message, which represents that the new CoA information of the mobile node has been recorded, to the AAAH.

(12) The AAAH creates a registration confirmation message to be transmitted to the nAR.

(13) The AAAH transmits the created registration confirmation message to the nAR.

(14) As soon as the nAR receives the registration confirmation message from the AAAH, the nAR authenticates the mobile node.

(15) The nAR transmits the registration confirmation message, which has been received from the AAAH, to the mobile node.

(16) Finally, the mobile node receives the registration confirmation message from the nAR. In addition, the mobile node acquires a session key created by the home agent, and thus can safely communicate with the nAR.

Hereinafter, a result of comparison between the conventional authentication method and a dual authentication method according to the present invention will be described.

Table 1 shows the definitions of system parameters necessary for performance estimation of the dual authentication method according to the present invention.

TABLE 1

| Variable | Description | Value | |
|---|---|---|---|
| Bₗ | Transmission rate in non-wireless | 100 | Mbps |
| | network | | |
| B_{w} | Transmission rate in wireless | 2 | Mbps |
| | network | | |
| βₗ | Propagation time in non-wireless | 0.5 | msec |
| | network | | |
| β_{w} | Propagation time in wireless network | 2 | msec |
| Γ | Message processing time | 0.5 | msec |
| T_{proc} | Additional processing time | 0.5 | msec |
| Tₒᵤₜ | Time for determination of message | 2 | msec |
| | loss | | |
| Q | Probability of message loss | 0.5 | |
| Tₗ | Message transmission time in non- | | |
| | wireless links | | |
| T_{w} | Message transmission time in | | |
| | wireless links | | |
| SME_{create} | Signature creation time | 4.65 | msec |
| | (for IBE) | | |
| SME_{verify} | Signature verification time | 0.19 | msec |
| | (for IBE) | | |
| | DES encryption/decryption time | 0.044 | msec |
| | (for standard) | | |
| | MD5 encryption/decryption time | 0.0048 | msec |
| | (for standard) | | |
| | RSA 1024 encryption time | 0.18 | msec |
| | (for standard) | | |
| | RSA 1024 decryption time | 4.63 | msec |
| | (for standard) | | |

Total Authentication Time

Based on the message transmission process described with reference to FIG. 1 and the system parameters shown in Table 1, the total authentication time of the authentication method according to the present invention is calculated as described below.

(1) Sum of the processing times (SPT): A processing procedure is required for packets received in steps (1), (3), (5), (6), (8), (10), (12), (14) and (16) described above with reference to FIG. 1. When it is assumed that each step requires the same processing time (T_{proc}), the following Equation is derived.

SPT=9T_{proc}

(2) Sum of the message signature creation/verification times (Sum of the message encryption and decryption time; SME): Signature creation is required in steps (1), (8) and (10) described above with reference to FIG. 1, and Signature verification is required in steps (3), (5), (6), (8), (14) and (16) described above with reference to FIG. 1. Accordingly, the following Equation for the “SME” is derived.

SME=3SME_{create}+6SME_{verify}

(3) Sum of the message transmission times in wired links (SMT₁): Message transmission in wired links is performed in steps (7), (9), (11) and (13) as described above with reference to FIG. 1. Accordingly, the following Equation for the “SMT₁” is derived.

SMT₁=4T₁

(4) Sum of the message transmission time in wireless links (SMT_{w}): Message transmission in wireless links is performed in steps (2), (4), and (15) described with reference to FIG. 1. Particularly, in step 2, since dual authentication is required, two messages are individually transmitted. Accordingly, the following Equation for the “SMT_{w}” is derived.

SMT_{w}=4(2M_{w}+Tₒᵤₜ)

The total processing time required for the dual authentication method proposed in the present invention may be expressed as a sum of values obtained from the four steps. Accordingly, the following Equation is derived.

T_{req}=SPT+SME+SMT₁+SMT_{w}

Authentication Failure Rate

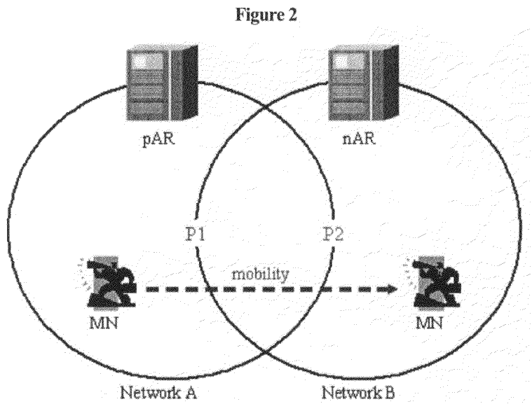

In order to calculate the authentication failure rate due to a ping-pong state in the dual authentication method according to the present invention, a random variable “T” is defined. The random variable “T” represents a time period during which a mobile node stays in an area, as shown in FIG. 2, where signals of different access routers overlap and thus a ping-pong state may occur.

The “T_{req}” calculated above represents a time period required for a mobile node to perform the dual authentication. Therefore, an authentication failure rate is expressed as the following equation.

P=Prob(T<T_{req})

In this equation, when it is assumed that the random variable “T” is exponentially distributed, the authentication failure rate may be expressed as follows:

P=Prob(T<T_{req})=1−exp(−λT_{req})<P_{f}

Herein, “λ” represents a rate at which a mobile node enters an overlapping coverage area, in which it is assumed that the moving directions of the mobile node are uniformly distributed on the interval [0;2π). Therefore, according to the prior art (“Influence of the moving of the mobile stations on the performance of a radio mobile cellular network” by R. Thomas, H. Gilbert, G. Mazziotto in Proceedings of the 3rd Nordic Seminar, 1988), “λ” is calculated by λ=VL/πS. Herein, “V” represents the velocity of a mobile node, and “L” represents the length of an overlapping coverage area wherein

$$L = \frac{1}{6} \times 2 π \times 2 l = \frac{2}{3} π l$$

(herein, “l” represents the radius of a circle which a signal of an access router reaches). Also, the size “S” of an overlapping coverage area is calculated as follows:

$$S = 2 ( \frac{1}{6} ( π {l}^{2} - \frac{\sqrt{3}}{4} \times {l}^{2} ) ) .$$

Thus, the authentication failure rate of the mobile node may be calculated in terms of “l” (radius of signal coverage) and “V” (velocity of mobile node). The authentication failure rate based on the size of “l” is expressed as follows:

$$l > \frac{4 {VT}_{req}}{( 2 π - 3 \sqrt{3} ) log ( 1 / ( 1 - {P}_{f} ) )} .$$

In addition, the authentication failure rate based on a change in “V” may be expressed as follows:

$$V < \frac{l ( 2 π - 3 \sqrt{3} ) log ( 1 / ( 1 - {P}_{f} ) )}{4 {T}_{req}} .$$

Comparison of Authentication Failure Rate

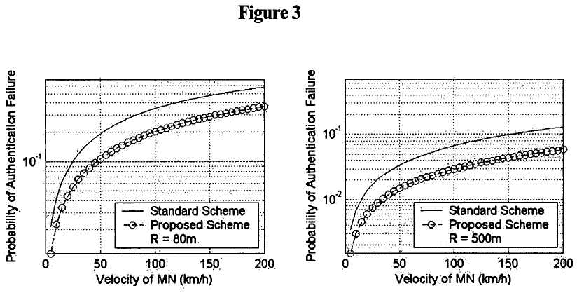

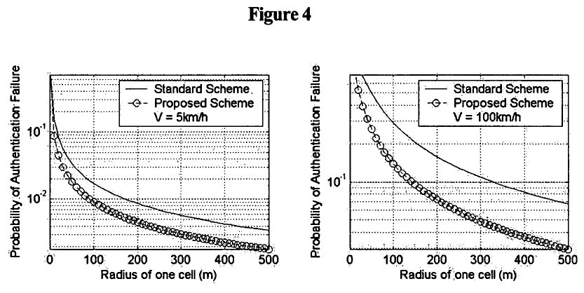

FIGS. 3 and 4 are graphs illustrating performance comparison in terms of the authentication failure rate between the dual authentication method according to the present invention and the conventional standard authentication method.

FIG. 3 shows a performance difference in the authentication failure rate based on the moving speeds of a mobile node between the dual authentication method according to the present invention and the conventional standard authentication method. In FIG. 3, the left-side and right-side graphs are obtained with signal coverage radiuses “R” of 80 m and 500 m, respectively, as a parameter. An increase in the value of the X-axis variable “V” means an increase in the speed of a mobile node. As the speed of a mobile node increases, the mobile node goes faster away from an overlapping coverage area, and thus a short authentication procedure is required. In terms of the moving speed “V” of the mobile node, The dual authentication method according to the present invention shows an authentication failure rate reduced by 17.4% as compared with the conventional standard authentication method, when V=50 km/h and R=80 m. Therefore, the dual authentication method according to the present invention can more stably perform authentication, in particular, even with respect to a mobile node moving at a high speed.

FIG. 4 shows a performance difference in the authentication failure rate based on signal coverage radiuses “R” between the dual authentication method according to the present invention and the conventional standard authentication method. As a signal coverage radius “R” increases, the overlapping coverage area in which a mobile node receives signals from different access routers increases, which means that the time period during which an authentication procedure can be performed increases. Therefore, generally, as the size of a signal coverage radius “R” increases, the authentication failure rate decreases. Referring to FIG. 4, in order to obtain an authentication failure rate of 10% when the moving speed of the mobile node is 100 km/h, the conventional standard authentication method requires a signal coverage radius “R” of 311.1 m, but the dual authentication method according to the present invention requires only a signal coverage radius “R” of 133.3 m. Consequently, in terms of the signal coverage radius “R,” the dual authentication method according to the present invention can achieve performance improvement by 57.1%.

The dual authentication method according to the present invention may be applied to mobile nodes based on IP such as Wibro. In addition, the dual authentication method according to the present invention may be applied to notebook computers and PDAs, equipped with IEEE 802.11 technology. Multimedia services made available by such mobile nodes may be used as a basic technology for various mobile application services, and is expected to contribute to developing security technology in a non-wireless/wireless integrated network environment in the future.

As described above, according to the present invention, when a mobile node enters a ping-pong state, dual authentication is performed, thereby preventing a failure of authentication in the ping-pong state, solving the buffering problem, and rapidly and safely performing authentication of the mobile node in the AAA environment. In addition, the dual authentication method according to the present invention advances the mobile node technology for the ubiquitous environment in which all terminals (i.e., nodes) are equipped with the IP protocol, thereby being used for various group application services as well as various multimedia services. The dual authentication method according to the present invention is expected to develop the security technology in non-wireless/wireless integrated network environments, and to activate various application services for mobile nodes.

The present invention is expected to contribute to indicating security requirements for authentication a mobile node in a mobile environment, and presenting an authentication technology to be expanded and developed to various application fields. Also, until now, no IT or security provider has developed such a dual authentication method as that of the present invention. Therefore, when the dual authentication method of the present invention is commercialized, the dual authentication method functions as a core security technology, so that it is expected that providers employing the dual authentication method have the foundation of a new security technology recognized in the inside and outside of the country future.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A dual authentication method for a mobile node which is in a ping-pong state where the mobile node is moving in an overlapping coverage area of a previous access router and a new access router, the method comprising the steps of:
allowing the previous access router to perform an authentication operation by reusing authentication information having been used in the previous access router, without requesting information required for authentication to an Authentication, Authorization, and Accounting (AAA) server, thereby rapidly performing the authentication of the mobile node.

2. The method as claimed in claim 1, wherein the dual authentication method is performed by using an ID-based encryption (IBE) scheme.

3. The method as claimed in claim 1, wherein the dual authentication method is performed in a Mobile IPv6 environment.

4. The method as claimed in claim 1, wherein when the mobile node is in a ping-pong state where the mobile node is moving in the overlapping coverage area of the previous access router and new access router, the mobile node creates a registration message based on a router advertisement message received from the new access router.

5. The method as claimed in claim 4, wherein the mobile node transmits the registration message to both the previous access router and the new access router at the same time.

6. The method as claimed in claim 5, wherein when the new access router receives an authentication request message from the mobile node, the new access router forwards the authentication request message to the AAA server.

7. The method as claimed in claim 6, wherein the AAA server transmits new Care-of-Address (CoA) information of the mobile node to a home agent (HA) so as to notify the home agent that the mobile node has moved to a new network.

8. The method as claimed in claim 7, wherein the home agent transmits to the AAA server a confirmation message that the new CoA information of the mobile node has been recorded, and the AAA server creates a registration confirmation message to be transmitted to the new access router.

9. The method as claimed in claim 8, wherein the AAA server transmits the created registration confirmation message to the new access router, and the new access router authenticates the mobile node as soon as the new access router receives the registration confirmation message from the AAA server.

10. The method as claimed in claim 9, wherein the new access router transmits to the mobile node the registration confirmation message received from the AAA server, and the mobile node receives the registration confirmation message from the new access router and acquires a session key created by the home agent, thereby safely communicating with the new access router.

11. A dual authentication method for a mobile node which is in a ping-pong state where the mobile node is moving in an overlapping coverage area of a pAR and a nAR, the method comprising the steps of:
creating, by the mobile node, a registration message based on a router advertisement message received from the new access router;
simultaneously transmitting the registration messages from the mobile node to the new access router and the previous access router;
performing authentication by the previous access router itself, without committing an authentication request message, which has been received from the mobile node, to an Authentication, Authorization, and Accounting (AAA) server;
transmitting, by the previous access router having performed the authentication, a response message to the registration message to the mobile node;
authenticating, by the mobile node, the response message received from the previous access router;
receiving, by the new access router, an authentication request message from the mobile node;
forwarding the authentication request message from the new access router to the AAA server in order to request authentication;
authenticating, by the AAA server, the authentication request message of the mobile node, which has been transmitted from the new access router;
transmitting new Care-of-Address (CoA) information of the mobile node from the AAA server to a home agent, in order to notify the home agent that the mobile node has moved to a new network;
recording, by the home agent, the new CoA information of the mobile node in a Binding Update List (BUL) of the home agent, thereby confirming that a handover has been performed;
transmitting, from the home agent to the AAA server, a confirmation message that the new CoA information of the mobile node has been recorded;
creating, by the AAA server, a registration confirmation message to be transmitted to the new access router;
transmitting the created registration confirmation message from the AAA server to the new access router;
receiving, by the new access router, the registration confirmation message transmitted from the AAA server, and authenticating the mobile node; and
transmitting the registration confirmation message, which the new access router has received from the AAA server, from the new access router to the mobile node.

12. The method as claimed in claim 11, wherein, after authenticating the response message received from the previous access router, the mobile node communicates with the previous access router by using a session key received from the previous access router.

13. The method as claimed in claim 11, wherein the mobile node acquires a session key created by the home agent, thereby safely communicating with the new access router.
